(19) United States
(12) Patent Application Publication
(10) Pub. No.: US 2019/0147218 A1
(43) Pub. Date: May 16, 2019

(54) USER SPECIFIC CLASSIFIERS FOR BIOMETRIC LIVENESS DETECTION

(71) Applicant: PRECISE BIOMETRICS AB, Lund (SE)

(72) Inventors: Peter JOHNSON, Madrid, NY (US); Stephanie SCHUCKERS, Canton, NY (US)

(73) Assignee: PRECISE BIOMETRICS AB, Lund (SE)

(21) Appl. No.: 16/098,673

(22) PCT Filed: May 3, 2017
(86) PCT No.: PCT/US2017/030836

§ 371 Date: Nov. 2, 2018

Related U.S. Application Data
(60) Provisional application No. 62/330,996, filed on May 3, 2016.

(51) Int. Cl. G06K 9/00

(52) U.S. Cl. CPC G06K 9/00107; G06K 9/00906; G06K 9/00087

(57) ABSTRACT

Various examples related to user specific classifiers for biometric liveness detection are provided. In one example, a method for determining biometric liveness includes extracting features from biometric data from a user; determining a liveness score based upon a comparison of the features to a feature template and a liveness classifier corresponding to the user; and determining biometric liveness of the user in response to a comparison of the liveness score with a liveness threshold. The liveness classifier can be based upon a baseline classifier associated with a group of users and previously obtained biometric enrollment data from the user. In another example, a processor system executes a liveness detection system to extract features from biometric data of a user; determine a liveness score; and determine biometric liveness of the user in response to a comparison of the liveness score with a liveness threshold.

### CROSS REFERENCE TO RELATED APPLICATIONS

This application claims priority to, and the benefit of, co-pending U.S. provisional application entitled “User Specific Classifiers for Biometric Liveness Detection” having Ser. No. 62/330,996, filed May 3, 2016, which is hereby incorporated by reference in its entirety.

### STATEMENT REGARDING FEDERALLY SPONSORED RESEARCH OR DEVELOPMENT

This invention was made with government support under agreement 1068055 awarded by the National Science Foundation. The Government has certain rights to the invention.

### SUMMARY

Embodiments of the present disclosure are related to user specific classifiers for biometric liveness detection.

In one aspect, among others, a method for determining biometric liveness, comprises obtaining biometric data from a user; extracting features from the biometric data; determining a liveness score based upon a comparison of the features to a feature template and a liveness classifier corresponding to the user, the liveness classifier based at least in part upon a baseline classifier associated with a group of users and previously obtained biometric enrollment data from the user; and determining biometric liveness of the user in response to a comparison of the liveness score with a liveness threshold. In one or more aspects, the method can further comprise creating the liveness classifier using the baseline classifier and the biometric enrollment data, the baseline classifier based at least in part upon biometric data from the group of users; and extracting the feature template from the biometric enrollment data. The baseline classifier can be based upon a set of biometric data associated with a plurality of individual subjects, the set of biometric data comprising live and spoofed biometric samples. The liveness threshold can be based upon an equal error rate (EER) evaluated using scores from the group of users evaluated on the baseline classifier. The biometric data can be fingerprint scan data.

In another aspect, a system comprises a processor system having processing circuitry including a processor and a memory; and a liveness detection system stored in the memory and executable by the processor to cause the processor system to: extract features from biometric data obtained from a user; determine a liveness score based upon a comparison of the features to a feature template and a liveness classifier corresponding to the user, the liveness classifier based at least in part upon a baseline classifier associated with a group of users and previously obtained biometric enrollment data from the user; and determine biometric liveness of the user in response to a comparison of the liveness score with a liveness threshold. In one or more aspects, the processor system can be a central server in a network. The biometric data can be received from an interface device configured to obtain the biometric data. The biometric data can be fingerprint scan data.

In one or more aspects, the processor system can be an interface device. The interface device can be a smart phone. In one or more aspects, the liveness detection system can cause the processor system to: create the liveness classifier using the baseline classifier and the biometric enrollment data, the baseline classifier based at least in part upon biometric data from the group of users; and extract the feature template from the biometric enrollment data. The liveness classifier can be stored in a classifier database and the feature template can be stored in a template database. The baseline classifier can be stored in a database. The liveness threshold can be based upon an equal error rate (EER) evaluated using scores from the group of users evaluated on the baseline classifier.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BACKGROUND

Due to the growing threat of spoofing attacks in biometric recognition technology, liveness detection is gaining interest as an additional security measure. With the types of features typically used for liveness detection, large amounts of variability across diverse populations can arise. Consequently, traditional methods of liveness detection, where a single classifier is constructed to represent an entire population, often have issues with generalizability.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a graphical representation illustrating an example of an implementation of a user specific classifier, in accordance with various embodiments of the present disclosure.

FIG. 2 is a schematic block diagram of one example of a processor system employed to detect biometric liveness and to perform various analysis with respect to the liveness detection, in accordance with various embodiments of the present disclosure.

FIG. 3 is an example of a histogram of false reject rate (FRR) values per subject for a baseline classifier, in accordance with various embodiments of the present disclosure.

FIG. 4 is an example of a histogram of FRR values per subject for user specific classifiers, in accordance with various embodiments of the present disclosure.

### DETAILED DESCRIPTION

Disclosed herein are various examples related to user specific classifiers for biometric liveness detection. An approach for conducting liveness detection in a biometric authentication system, which greatly reduces the variability in the classification problem, is described. A classifier can be tuned for each user who enrolls in the system, which can reduce the rate of false rejection for users who are otherwise rejected often. Reference will now be made in detail to the description of the embodiments as illustrated in the drawings, wherein like reference numbers indicate like parts throughout the several views.

A spoofing attack on a biometric system is where a malicious user attempts to present biometric characteristics belonging to a different person to the system in order to fool it into thinking that they are that person. These spoofing attacks are performed by presenting a forged replica of the victim's biometric trait. Some examples include fake fingers, photographs of faces, contact lenses with printed iris patterns, etc. These attacks pose a serious security risk to biometric recognition tasks and must be addressed.

To combat this threat, liveness detection has been proposed as a countermeasure, where a biometric sample is analyzed in such a way as to detect whether it was produced from the user's actual live trait or from an artificial replica. Liveness detection typically involves extraction of useful features from a biometric sample along with some machine learning technique to classify the source of the biometric characteristics as either live or fake. The classifier is trained on a set of biometric sample data to learn how to distinguish between the classes.

Many liveness detection methods analyze the finer details of a biometric sample (e.g., fingerprint, palm print, facial image, iris or retinal scan, or other biological identifier), beyond what is used for matching. For example, for many modalities, texture characteristics are used for liveness detection. At this level of detail, significant amounts of variation can arise across diverse populations of individuals. For example, age, race, sex, and even occupation (e.g., sustained manual labor can influence certain characteristics of a person's fingerprints) can all have an impact on this level of biometric characteristics.

In order to have the classifier generalized well, the set of training data should be representative of the entire target population for system deployment. In some applications, this could include millions or even billions of individuals (e.g., UIDAI). Even if it was feasible to collect such vast and diverse biometric samples, the complexity of the classifier would get quite large, given the growing number of degrees of freedom it must account for. This can adversely affect processing times of the system.

With the high variability in liveness characteristics, there is a high probability that some users will be rejected more often than others if they are not well represented by the classifier. The system becomes less user friendly if there are users which do not often pass liveness detection. The problem with this type of framework is that liveness detection is not guaranteed to work for all users of a system.

Given all of these difficulties in the classification task for biometric liveness detection, an approach is disclosed that significantly reduces the amount of variability encountered in a deployment scenario. The approach utilizes the enrollment process already utilized for matching purposes to build a user specific classifier for the user who is enrolling in the system. Then, at authentication, the user's biometric samples can be verified by liveness detection using a classifier matched to their identity. This way, the classifier can be tuned specifically for that user and false rejections by the liveness detector can be minimized. As a result, liveness detection will work better with improved accuracy and reduced processing times for all users of the system.

In a practical scenario, when a user enrolls their biometric trait in a system, one or more biometric samples are captured by the sensor, which are used to update an existing classifier to be tuned to that particular user. When the user interacts with the system in authentication mode, the samples presented are tested against the user specific classifier to verify that it is from that user's live biometric.

The liveness detection framework comprises three stages of operation. The first stage includes initializing the system prior to the enrollment of any users. In the initialization stage, a set of biometric data corresponding to a multitude of persons, comprising both live and spoofed samples is compiled. A spoofed sample is biometric data captured from a forged replica of a biometric trait. This data can be used to build a general liveness classifier for the classification of sample data as resulting from a live or fake source.

The second stage includes enrollment of users. When a user is enrolling in a system, a biometric template for matching can be constructed and then the general liveness classifier can be modified to represent the new user, creating a user specific classifier. This results in a separate classifier for each user. Alternatively, the general classifier can be updated incrementally for each user that is enrolled in the system, resulting in a single classifier representing all enrolled users of the system.

The third stage involves authentication of users. When a user returns to the system for identity verification, their biometric can be presented to the sensor and a sample captured. From this sample, characteristics for matching can be extracted and the user's template identified. Next, characteristics for liveness detection can be extracted from the captured sample. The selected template has a corresponding liveness classifier, which can be used to classify the liveness characteristics and the sample can be judged to be either from a living biometric or from a fake biometric. If the sample is deemed to be from a fake biometric, the presentation can be labeled as fraudulent and the user rejected by the system.

Given that there is a certain amount of error in the decisions provided by both the matching aspect as well as the liveness detection aspect of the system, fusion can be conducted to leverage knowledge gained from the matching component for liveness detection and vice versa, thereby reducing the overall error of the system. Various techniques can be employed to perform fusion of information from matching and liveness detection. The different possible levels of fusion can include feature level, score level, and decision level. Fusion strategies can include rule-based methods (e.g., min, max, sum, product, and/or majority voting), density estimation methods using the likelihood ratio statistic, and discriminative methods (e.g., support vector machines (SVMs), neural networks, linear discriminative analysis, etc.).

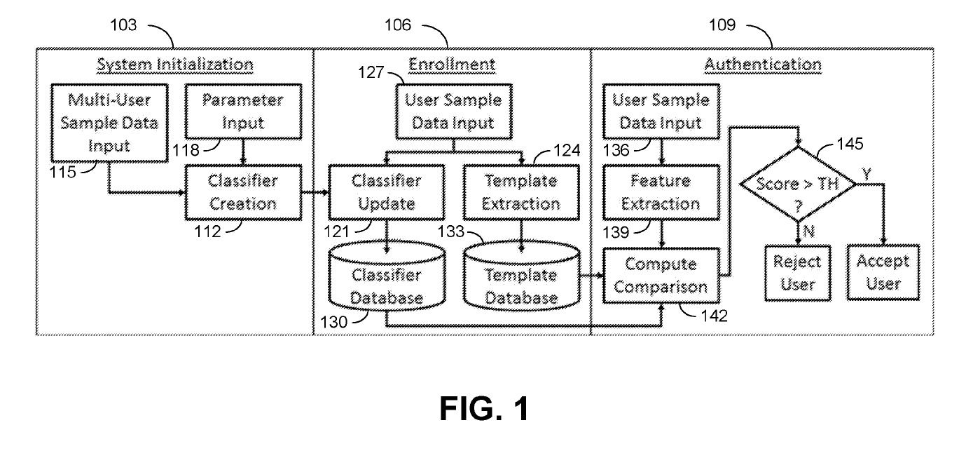

An example of the system 100 for user specific classifiers is diagramed in FIG. 1, showing the three stages of system operation: initialization 103, enrollment 106 and authentication 109. The first stage (initialization) 103 creates 112 a general classifier from a sample dataset 115 composed of many users, where these users are assumed to be independent from any user that would enroll in the system 100. Parameters may be input 118 (or defined) for the classifier creation 112. The second stage (enrollment) 106 creates or updates a liveness classifier 121 and extracts a feature template 124 for the enrolling user input data 127 and stores them in their respective classifier database 130 and template database 133. Finally, at the third stage, the user presents their biometric to the sensor to produce the user sample data 136, and features for matching and liveness are both extracted 139. Matching features are compared 142 to the template stored in the template database 133, and liveness features are classified 142 using the stored liveness classifier 130 for that user. The probability estimates of a successful match and a live biometric detection are then fused and a decision 145 is made on whether to accept or reject the user. The decision output can then be used to control access of the user.

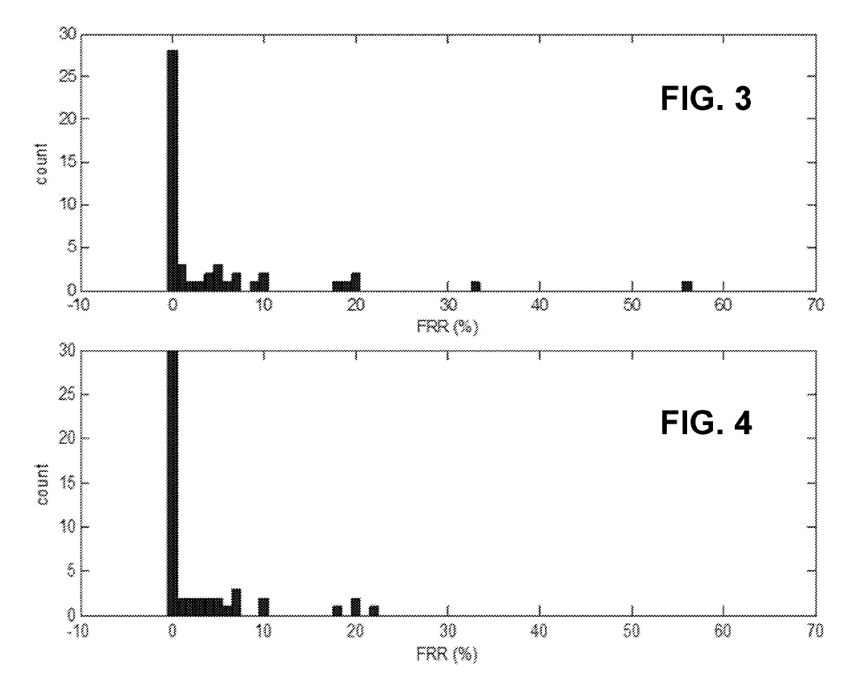

An example of the computation of liveness scores for user specific classifiers can be described following the framework of FIG. 1. Given a test subject k, of N total subjects, with biometric samples captured on collection day l, of M total collection days, a baseline classifier can be created 112 utilizing, e.g., all biometric samples (live and spoof) from all subjects i=1, . . . , N i≠k in the sample dataset 115. A user-specific liveness classifier 121 can be created by combining the training data 115 from the baseline classifier with all input data 127 captured from subject k, captured on collection days j=1, . . . , M j≠l. The testing data for these classifiers can then be formed by gathering all samples 136 captured from subject k on collection day l. For each of these test samples 136, a feature vector measuring liveness characteristics can be extracted 139, which is input into each of the classifiers (baseline and user-specific) to compute liveness scores for classification 142. Each liveness score can be classified as either live (accept user) or spoof (reject user) by applying the corresponding threshold 145. This process for subject k can be repeated for each collection day j=1, . . . , M, with the false reject rate (FRR) computed for subject k. The entire process can then be repeated for each subject k=1, . . . , N, giving an individual FRR for each subject. Examples of the histograms of FRRs are presented in FIG. 3 for the baseline classifiers and FIG. 4 for the user-specific classifiers.

An important feature of the disclosed approach to biometric liveness detection is the classifier update component 121. Multiple methods may be used for updating a classifier for an enrolled user, each with its own strengths given the particular application. A range of biometric authentication applications are presented below, with appropriate implementations of user specific classifiers outlined for each application.

For a large scale system implementation, which can comprise a network of devices, where a user may enroll on one device and authenticate on a different device, a cloud or distributed solution may be optimal. In one embodiment, a central server can perform the processing and supply the storage unit for the biometric data including the classifier database 130 and template database 133. Then, when a user interacts with an interfacing device on the network (for enrollment or authentication), the biometric data can be securely transmitted to the central server, where the classification processing can be implemented. The decision on whether the biometric sample is fraudulent or not can then be sent back to the interfacing device and appropriate action taken based on whether the user was accepted or rejected by the system.

In another embodiment, a slightly different approach can allow more of the processing to be done on the interfacing device and provide better privacy protection. Assuming the biometric matching is performed on the interfacing device, a central server could be utilized strictly for classifier update. In this implementation, the interfacing device can extract features for liveness, which are transmitted to the central server. The central server can train the classifier, incorporating the user's data with a larger set of training data and the classifier can be transmitted back to the interfacing device and stored for when that user attempts to authenticate using that interfacing device.

For embodiments comprising single isolated device applications, such as access control for an interfacing device such as mobile phones, tablets or other mobile devices, a different approach may be more appropriate. For example, transmission of biometric data to a central server may be more of a risk than it's worth, or may not even be possible. The alternative is to have all processing and storage on the interfacing device. Given that some interfacing devices in this category may have storage limitations, storing the entire training dataset may not be feasible. In that case, an incremental training approach can be utilized. Applicable approaches have been outlined in literature listed below for discriminative-based classifiers and density-based classifiers. If storage limitations on the interfacing device are too restrictive to save an individual classifier for each enrolled user, a single device specific classifier can be used instead. The device specific classifier can be incrementally trained for each user who enrolls on the device and would be representative of all enrolled users.

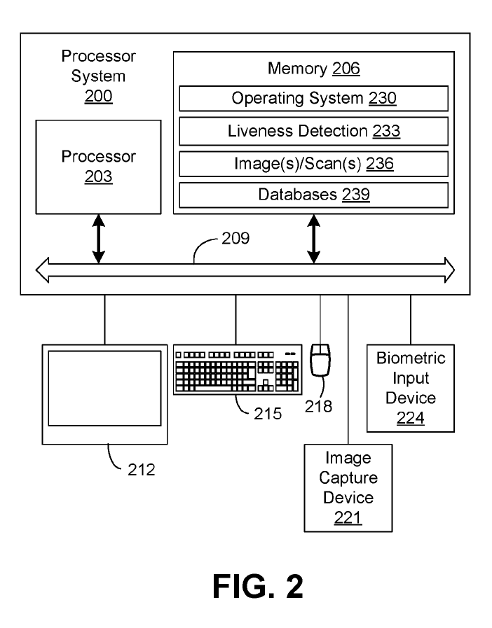

Referring to FIG. 2, shown is one example of a processor system (e.g., an interfacing device, central server, server or other network device) that performs various functions using user specific classifiers for biometric liveness detection according to the various embodiments as set forth above. As shown, a processor system 200 is provided that includes at least one processor circuit, for example, having a processor 203 and a memory 206, both of which are coupled to a local interface 209. The local interface 209 may be, for example, a data bus with an accompanying control/address bus as can be appreciated by those with ordinary skill in the art. The processor system 200 may comprise, for example, a computing system such as a server, desktop computer, laptop, personal digital assistant, smart phone, tablet or other system with like capability.

Coupled to, or integrated in, the processor system 200 are various interface devices such as, for example, a display device 212, a keyboard 215, and/or a touchpad or mouse 218. In addition, other peripheral devices that allow for the capture of various patterns may be coupled to the processor system 200 such as, for example, an image capture device 221 or a biometric input device 224. The image capture device 221 may comprise, for example, a digital camera or other such device that generates images that comprise patterns to be analyzed as described above. Also, the biometric input device 224 may comprise, for example, a fingerprint input device, optical scanner, or other biometric device 224 as can be appreciated.

Stored in the memory 206 and executed by the processor 203 are various components that provide various functionality according to the various embodiments of the present invention. In the example embodiment shown, stored in the memory 206 is an operating system 230 and a liveness detection application 233. In addition, stored in the memory 206 are databases 239 (e.g., classifier and template databases 130/133), various images and/or scans 236, and potentially other information associated with the biometrics. Information in the databases 239 may be associated with corresponding ones of the various images 236. The images 236 may be stored and indexed in a database, and the databases 239 may be accessed by the other systems as needed. The images/scans 236 may comprise fingerprint, palm print, facial image, iris or retinal scan, or other biological identifier as can be appreciated. The images/scans 236 comprise, for example, a digital representation of physical patterns or digital information such as data, etc.

The liveness detection application 233 is executed by the processor 203 in order to classify whether a biometric is “live” or “not live” as described above. A number of software components are stored in the memory 206 and are executable by the processor 203. In this respect, the term “executable” means a program file that is in a form that can ultimately be run by the processor 203. Examples of executable programs may be, for example, a compiled program that can be translated into machine code in a format that can be loaded into a random access portion of the memory 206 and run by the processor 203, or source code that may be expressed in proper format such as object code that is capable of being loaded into a of random access portion of the memory 206 and executed by the processor 203, etc. An executable program may be stored in any portion or component of the memory 206 including, for example, random access memory, read-only memory, a hard drive, compact disk (CD), floppy disk, or other memory components.

The memory 206 is defined herein as both volatile and nonvolatile memory and data storage components. Volatile components are those that do not retain data values upon loss of power. Nonvolatile components are those that retain data upon a loss of power. Thus, the memory 206 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

The processor 203 may represent multiple processors and the memory 206 may represent multiple memories that operate in parallel. In such a case, the local interface 209 may be an appropriate network that facilitates communication between any two of the multiple processors, between any processor and any one of the memories, or between any two of the memories etc. The processor 203 may be of electrical, optical, or molecular construction, or of some other construction as can be appreciated by those with ordinary skill in the art.

The operating system 230 is executed to control the allocation and usage of hardware resources such as the memory, processing time and peripheral devices in the processor system 200. In this manner, the operating system 230 serves as the foundation on which applications depend as is generally known by those with ordinary skill in the art.

Although the liveness detection application 233 is described as being embodied in software or code executed by general purpose hardware as discussed above, as an alternative the same may also be embodied in dedicated hardware or a combination of software/general purpose hardware and dedicated hardware. If embodied in dedicated hardware, each of the liveness detection application 233 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow diagram of FIG. 1 shows functionality, and operation of portions of an implementation of the liveness detection application 233. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although flow diagram of FIG. 1 shows a specific order of execution, it is understood that the order of execution may differ from that which is depicted. For example, the order of execution of two or more blocks may be scrambled relative to the order shown. Also, two or more blocks shown in succession in FIG. 1 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the liveness detection application 233 may comprise software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the liveness detection application 233 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

### EXPERIMENTAL RESULTS

To test the influence of adding data from the user in the training set to build a user specific classifier, the following experiment was performed. Fingerprint images were collected from one finger of a number of subjects. For each subject, a baseline classifier was trained using all other subjects. A second classifier was then trained by incorporating a single collection day (enrollment 106 of FIG. 1) from the subject of interest into the larger training set. The data from the remaining collection days from the subject of interest was set aside for testing. This testing set was used to evaluate each of the trained classifiers and a liveness score for each image was saved. A constant threshold value can be selected based on the equal error rate (EER) evaluated using the scores from all of the subjects evaluated on the baseline classifier. This threshold was then applied to the scores from each subject, obtained from the user specific classifier. The false accept rate (FAR) and false reject rate (FRR) were then recorded for each subject on each classifier.

The dataset used for evaluation of the user specific classifiers for the biometric liveness detection system comprised a collection of fingerprint images from 50 subjects, including images from both real and spoofed fingerprints. Live samples were collected from a single finger from each subject at multiple collection events. These collection events were separated by multiple days to take into account the variability of biometric characteristics that can arise over time. This allows for a more realistic simulation of “in the field” use of the system, where a user generally is authenticated by the system on a separate day from when that user enrolled in the system. Spoofed samples were captured from fake finger replicas of each live finger represented in the live sample set. These fake fingers were formed by first taking impressions of the live fingers in a high quality mold material. The fake finger was then formed by casting one of several materials in the mold. The casting materials included in this dataset were latex, Play-Doh, gelatin, silicone, and paint.

The combined dataset consisted of 1770 live images and 772 spoofed images. Under the assumption that a live biometric is always presented at enrollment, four types of enrollment-authentication comparisons can be made from these images: live-live genuine (match), live-live impostor (non-match), live-spoof genuine (match), and live-spoof impostor (non-match). For this analysis, the non-match cases were excluded under the assumption that an ideal matching component was implemented in the system, i.e. the false match rate and false non-match rate were both zero. This allowed the focus of the analysis to be on the liveness detection capabilities of the system. There were an average of 261 live-live comparisons made per subject in this database, where the liveness score for each comparison was computed from the live sample taken at authentication and there were an average of 134 live-spoof comparisons made per subject, where the liveness score for each comparison was computed from the spoof sample taken at authentication.

For validation of the user specific classifier framework, the FRR values for each subject were compared between classifiers. It was observed that the FRR decreased for 9 of the 50 subjects when switching to the user specific classifier. The average decrease in FRR for these 9 subjects was 9.69%. The average decrease in FRR over all of the subjects that did not initially have 0% FRR was 3.96% (there are 13 subjects that had a baseline FRR greater than zero that saw no decrease in FRR with the user specific classifier). The FAR for each subject increased by 0.19% on average.

Overall, with the baseline classifier, there were 6 subjects with FRRs over 10% and 2 over 20%. With the user specific classifier, there were 4 subjects with FRRs over 10% and 1 over 20%. The two most significant outliers from the baseline classifier were FRR=33.1% and FRR=55.6%. These two subjects changed to FRR=5.3% and FRR=22.2% respectively with the user specific classifier. FIG. 3 shows the histogram for the FRR values per subject for the baseline classifier and FIG. 4 shows the histogram for the FRR values per subject for the user specific classifiers.

A method for performing biometric liveness detection has been demonstrated, where general user independent liveness classifiers can be updated during user enrollment to become user specific classifiers, which can in turn be used during user authentication to protect against biometric spoofing attacks. The results show that when updating a classifier with added data from the specific user, that user tends to be rejected less often. In particular, the outlying users (those with highest initial FRR) seem to benefit the most. The results also show a relatively insignificant change in FAR when switching to the user specific approach.

The analysis of the fingerprint as conducted by the liveness detection application described above has been shown to be a robust approach for distinguishing between live and fake fingerprints. The application is computationally simple and efficient, capable of being implemented on a wide range of computing platforms. With the use of this liveness detection application in biometric recognition systems, significant security vulnerabilities can be protected against, allowing the technology to be used more broadly with greater confidence.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for determining biometric liveness, comprising:
obtaining biometric data from a user;
extracting features from the biometric data;
determining a liveness score based upon a comparison of the features to a feature template and a liveness classifier corresponding to the user, the liveness classifier based at least in part upon a baseline classifier associated with a group of users and previously obtained biometric enrollment data from the user; and
determining biometric liveness of the user in response to a comparison of the liveness score with a liveness threshold.

2. The method of claim 1, comprising:
creating the liveness classifier using the baseline classifier and the biometric enrollment data, the baseline classifier based at least in part upon biometric data from the group of users; and
extracting the feature template from the biometric enrollment data.

3. The method of claim 2, wherein the baseline classifier is based upon a set of biometric data associated with a plurality of individual subjects, the set of biometric data comprising live and spoofed biometric samples.

4. The method of claim 1, wherein the liveness threshold is based upon an equal error rate (EER) evaluated using scores from the group of users evaluated on the baseline classifier.

5. The method of claim 1, wherein the biometric data is fingerprint scan data.

6. A system, comprising:
a processor system having processing circuitry including a processor and a memory; and
a liveness detection system stored in the memory and executable by the processor to cause the processor system to:
extract features from biometric data obtained from a user;
determine a liveness score based upon a comparison of the features to a feature template and a liveness classifier corresponding to the user, the liveness classifier based at least in part upon a baseline classifier associated with a group of users and previously obtained biometric enrollment data from the user; and
determine biometric liveness of the user in response to a comparison of the liveness score with a liveness threshold.

7. The system of claim 6, wherein the processor system is a central server in a network.

8. The system of claim 7, wherein the biometric data is received from an interface device configured to obtain the biometric data.

9. The system of claim 8, wherein the biometric data is fingerprint scan data.

10. The system of claim 6, wherein the processor system is an interface device.

11. The system of claim 10, wherein the interface device is a smart phone.

12. The system of claim 6, wherein the liveness detection system causes the processor system to:
create the liveness classifier using the baseline classifier and the biometric enrollment data, the baseline classifier based at least in part upon biometric data from the group of users; and
extract the feature template from the biometric enrollment data.

13. The system of claim 12, wherein the liveness classifier is stored in a classifier database and the feature template is stored in a template database.

14. The system of claim 12, wherein the baseline classifier is stored in a database.

15. The system of claim 6, wherein the liveness threshold is based upon an equal error rate (EER) evaluated using scores from the group of users evaluated on the baseline classifier.
